(19) United States
(12) Patent Application Publication
(10) Pub. No.: US 2009/0210770 A1
(43) Pub. Date: Aug. 20, 2009

(54) METHOD, SYSTEM AND COMPUTER PROGRAM PRODUCT FOR END TO END ERROR CHECKING IN ETHERNET

(75) Inventors: Casimer DeCusatis, Poughkeepsie, NY (US); Thomas A. Gregg, Highland, NY (US)

Correspondence Address: CANTOR COLBURN LLP-IBM POUGHKEEPSIE, 20 Church Street, 22nd Floor, Hartford, CT, 06103, US

(73) Assignee: INTERNATIONAL BUSINESS MACHINES CORPORATION, ARMONK, NY (US)

(21) Appl. No.: 12/031,117

(22) Filed: Feb. 14, 2008

(51) Int. Cl. G06F 11/10

(52) U.S. Cl. 714/758; 714/776; 714/E11.032

(57) ABSTRACT

A method for network protocol error correction comprising, generating a data packet including a cycle redundancy check (CRC) field, an end to end error field that remains unchanged as the data packet is sent over a network, for use in performing error detection in one or more field of the data packet, and a flag field associated with the end to end field to indicate that the end to end error field contains error correction data, and sending the data packet over a network via an Ethernet protocol.

### BACKGROUND OF THE INVENTION

This invention relates generally to Ethernet, and more particularly to providing error checking in an Ethernet protocol.

Ethernet is a frame-based networking technology for local area networks. The Ethernet protocols are standardized in, for example, IEEE 802.3. Data is sent via Ethernet protocols over networks via switches, bridges, and hubs that are hardware devices designed to transmit data with the Ethernet protocol.

Data Center Ethernet (DCE) is a modification of the Ethernet standard that may allow Ethernet to be a preferred protocol for all types of data center network traffic. This may also be known by other names, such as, for example, low latency Ethernet, next generation Ethernet, or Fibre Channel over Ethernet. Many data centers use different protocols for transmitting data that offer features not available in the Ethernet protocol, such as more robust error checking. However, the use of many different protocol standards in data centers leads to problems in implementing data center systems.

It would be desirable to develop a DCE protocol that takes advantage of the prevalent use of the Ethernet protocol and incorporates additional features for data center use.

### BRIEF SUMMARY OF THE INVENTION

An exemplary method includes method for network protocol error correction comprising, generating a data packet including a cycle redundancy check (CRC) field, an end to end error field that remains unchanged as the data packet is sent over a network, for use in performing error detection in one or more field of the data packet, and a flag field associated with the end to end field to indicate that the end to end error field contains error correction data, and sending the data packet over a network via an Ethernet protocol.

An exemplary embodiment includes, a system for transmitting data comprising a transmitter operative to generate a data packet including a cycle redundancy check (CRC) field, an end to end error field that remains unchanged as the data packet is sent over a network, for use in performing error detection in one or more field of the data packet, and a flag field associated with the end to end field to indicate that the end to end error field contains error correction data, and to send the data packet over a network via an Ethernet protocol.

An alternate exemplary embodiment includes, a computer program product for providing real-time recommendations, the computer program product comprising, a computer-readable storage medium for storing instructions for executing a real-time recommendation service, the real-time recommendation service comprising a method of, generating a data packet including a cycle redundancy check (CRC) field, an end to end error field that remains unchanged as the data packet is sent over a network, for use in performing error detection in one or more field of the data packet, and a flag field associated with the end to end field to indicate that the end to end error field contains error correction data, and sending the data packet over a network via an Ethernet protocol.

### BRIEF DESCRIPTION OF THE DRAWINGS

Referring now to the drawings wherein like elements are numbered alike in the several FIGURES:

FIG. 1 illustrates an example of a data network.

FIG. 2 illustrates an exemplary embodiment of a data packet.

FIG. 3 illustrates an exemplary embodiment of a method for transmitting a data packet.

FIG. 4 illustrates an exemplary embodiment of a method for determining data packet errors.

FIG. 5 illustrates an alternate exemplary embodiment of a data packet.

### DETAILED DESCRIPTION OF EXEMPLARY EMBODIMENTS

An exemplary embodiment of the present invention provides improved error checking in an Ethernet protocol.

As data packets are transmitted and received through a network, bit errors often occur in the data packets. The Ethernet (type II) protocol (as defined in IEEE 802.3) provides a frame check sequence (FCS) field that checks for errors. As a data packet is received and transmitted by switching nodes in a network, each node implements error detection to avoid wasting bandwidth by transmitting erroneous frames. When a node detects and error, it discards the frame rather than forwarding on to the next node. A cyclic redundancy check (CRC) is used for error detection.

Data packets sent via the Ethernet protocol are commonly switched at a data link layer (layer 2 of the Open Systems Interconnect (OSI) model) that uses a Media Access Control (MAC) address for switching. As data packets are received and transmitted at switching nodes, frames with errors are detected using the CRC. Often, the switching nodes regenerate the CRC and attach a new CRC to the data packet before transmitting the data packet to another node. The regeneration of the CRC at nodes in a network may lead to errors that may be undesirable in some applications, for example, errors such as corrupted data and header information.

Data centers use a number of different protocols that offer advantages over the Ethernet (type II) protocol. One advantage of other protocols is more robust error checking schemes. However, the use of a variety of protocols in data centers creates difficulties in designing and updating data centers. The prevalence of the Ethernet protocols makes Ethernet an attractive protocol for a standardized data center protocol, however, the current Ethernet (type II) protocol does not offer the error detection features desirable in a data center protocol. Data Center Ethernet (DCE) is a proposed protocol for use in data centers. An exemplary embodiment of the present invention includes an improved DCE protocol with more robust error checking. The industry has recognized that there are advantages in terms of simplification and cost reduction to be obtained from converging the existing multiple data center networks into a single network. Due to its widespread use, Ethernet is considered the preferred protocol for network convergence. There have thus been several initiatives proposed to run other protocols such as Fibre Channel over Ethernet. There have been several proposals to the IEEE high speed study group (HSSG) that governs the 802.3 standard to incorporate new features into Ethernet, supported by a consortium of companies. These proposals address required modifications to the existing Ethernet protocol that will enable features currently found in other protocols, and thus make it possible to run other protocols over Ethernet without giving up essential functionality provided by other protocols.

There are several error checking methods including, for example, cyclic redundancy check (CRC), and checksum. CRC field data is often four bytes in length. At a transmitter, a data packet is processed by a collection of exclusive or circuits, four bytes at a time. The intermediate result is stored in a four byte register, and when all the data has been processed, the register contains the CRC field. This field is then appended to the end of the frame containing the data. At the receiver, the CRC is generated in an similar manner. When all the data has been processed, the receiver compares the received CRC at the end of the frame to the CRC the receiver generated. If the CRC fields match, the data has no errors. Another method of error checking is the checksum. While the checksum is generally considered not as robust as CRC, it is easy for computer processors to generate. At a transmitter generating, for example, a four byte checksum, the data is added four bytes at a time, and any ‘carry-out’ is discarded (modulo 4 byte). After all the data is added, the four byte result is appended to the end of the frame containing the data. At the receiver, a similar process is performed, and the checksums are compared. If the checksums are the same, the data has a high probability of having no errors.

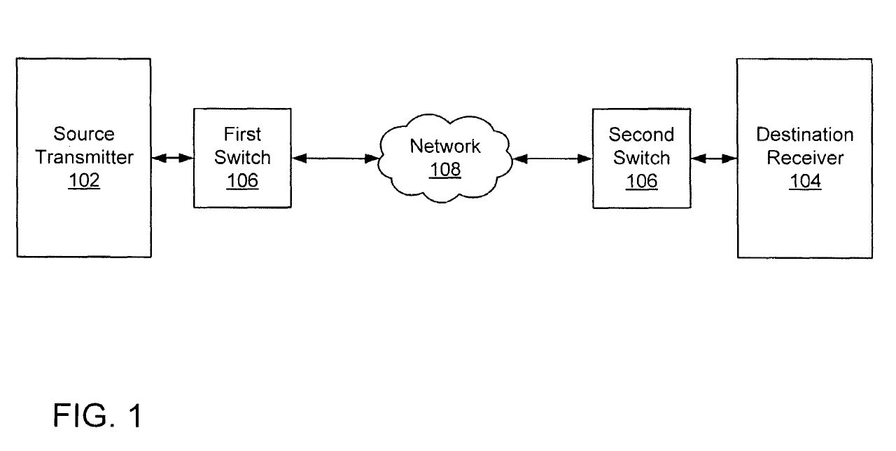

FIG. 1 illustrates an example of a network including a source transmitter 102 communicatively connected to a first switch 106. The first switch 106 is communicatively linked to a network 108 that may include, for example, additional nodes having switches. The network 108 is communicatively linked to a second switch 106 that is communicatively linked to a destination receiver 104.

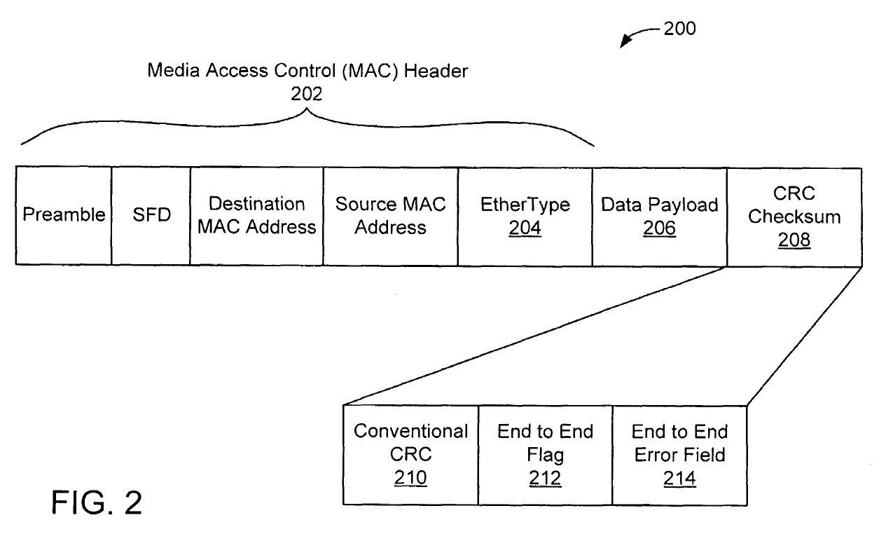

A proposed addition to the DCE protocol is end to end error checking. FIG. 2 illustrates an exemplary embodiment of a DCE data packet 200 having a variety of fields. The data packet 200 includes a MAC header 202, a payload field 206 that holds the sent data, and a CRC checksum field 208. In a conventional Ethernet (type II) data packet, the CRC checksum field is used to determine if data errors exist as the data packet is transmitted and received by switches in the network 108. At some switches in the network, the CRC checksum field 208 may be regenerated and transmitted to other switches in the network 108. This may lead to data errors that are undesirable in a data center. This recalculation of the CRC exposes the frame to data corruption within a switch node, and clearly, this is not an acceptable situation in a data center. For example, excessive bit errors may cause multiple requests for re-transmission of data, which consume network bandwidth and server resources.

End to end error detection is a method that incorporates an error checking field in a data packet that is generated at, for example, the source transmitter 102 and remains unchanged as the data packet is received and transmitted between switches in the network 108. When the destination receiver 104 receives the data packet, the end to end error checking field contains the same information as when it was generated by the source transmitter 102. End to end error checking offers a more robust error checking method than the CRC used in the current Ethernet (type II) protocol since the end to end error checking field remains unchanged in the transmission process.

Referring to FIG. 2, the data packet 200 includes an expanded CRC checksum field 208. The CRC checksum field 208 includes a conventional CRC field 210. The CRC checksum field 208 also includes an end to end flag field 212, and an end to end error field 214. The sequence of the checking fields and flag may be different and is not limited to that shown in FIG. 2.

The illustrated embodiment of FIG. 2 includes end to end error data that is used to check for errors in the data payload 206. However, the end to end error data is not limited to data errors in the payload 206, and may be used to check for data errors in other fields of the data packet 200. In particular, the end to end checking field may cover all invariant fields in the frame such as the payload and many of the header bits.

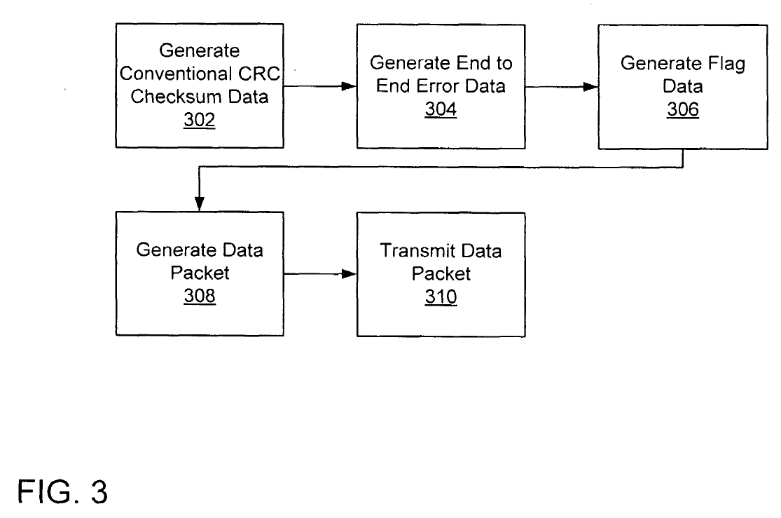

FIG. 3 illustrates an exemplary embodiment of block diagram describing a method used to transmit and receive the data packet 200. In operation, the source transmitter 102 (of FIG. 1) generates the data packet 200. The data packet 200 may include conventional CRC data in the conventional CRC field 210. The conventional CRC data is similar to the CRC checksum of the current Ethernet (type II) protocol, and is generated and used in a similar manner in block 302. The source transmitter 102 may also generate data for the end to end error field 214 in block 304. The end to end error field 214 includes end to end error checking data. The end to end error checking data may, for example, include a CRC, or a checksum. This approach requires modifications to the FCS field of an Ethernet frame. At layer 3 the packets and their contents may be rescrambled to facilitate transmission, making it desirable to perform error checking at layer 2. An Ethernet switch typically creates a permanent virtual circuit (PVC) that is a logical end-to-end link mapping over the physical network.

Expanding the FCS field by the addition of a subfield that would be transparent to the PVC, and would thus be able to flow across the network transparently to the switching nodes. In one embodiment, this new field would contain identification bits that indicate whether it was turned on or off, followed by a CRC checksum that was appended at the data source. This checksum flows across the PVC to the destination node, where it is identified and used to validate the entire network.

In block 306, the source transmitter 102 also generates an end to end flag in the end to end flag field 212. The end to end flag indicates whether the data packet 200 includes end to end error data in the end to end error field 214. The end to end flag field 212 may, for example, contain a flag bit.

Once the source transmitter 102 has generated the data packet 200 in block 304, the data packet 200 is sent, in block 306, to the destination receiver 104 via the switches 106 and the network 108. Though the data in the conventional CRC field 210 may be changed as the data packet is transmitted via the switches 106 and the network 108, the end to end error data in the end to end error field 214 remains unchanged.

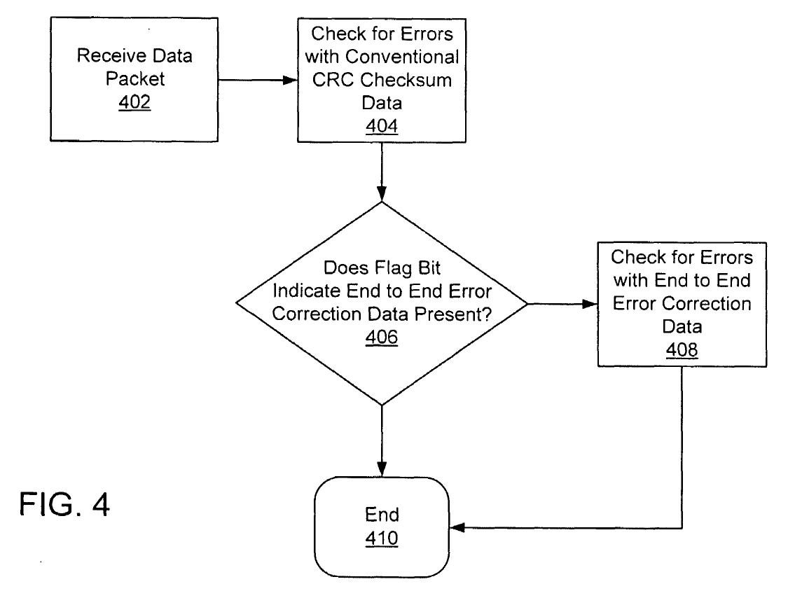

FIG. 4 illustrates an exemplary embodiment of a method for receiving and checking for errors in the data packet 200. In block 402, the data packet 200 is received by the destination receiver 104. The destination receiver may check for errors using the conventional CRC data in block 404. The destination receiver 104 then determines whether end to end data is present in the data packet 200 by checking the end to end flag field 212 in block 406. If the end to end flag field 212 indicates that end to end error data is present in the data packet 200, the destination receiver 104 may process the end to end data to check for errors in the data packet 200 in block 408. Once the end to end data is used to check for errors the process ends in block 410. Once the process ends, if data errors are determined, the data errors may be corrected using standard error correction techniques such as, for example, retransmission of the frames in error.

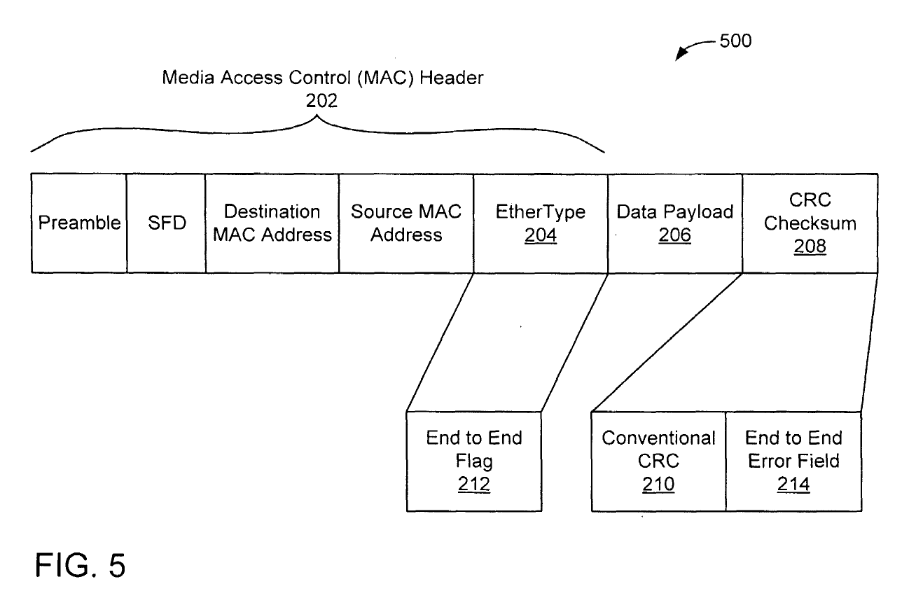

An alternate embodiment of a data packet 500 is illustrated in FIG. 5. The data packet 500 includes the end to end flag field 212 and the end to end error checking field 214. However, the end to end flag field 212 is included in an EtherType field 204 that is included in the MAC header 202. The end to end error checking field 214 is included in the CRC checksum field 208. The data packet 500 may be generated, transmitted and received in a method similar to the methods described above in FIGS. 3 and 4.

Though the embodiments of the data packets having an end to end error field 214 and an end to end flag field 212 described above illustrate the fields as being included in the CRC checksum field 208 and the EtherType field 204, embodiments of the data packets are not limited by these examples. Other embodiments may include an end to end error field 214 and an end to end flag field 212 in other fields used in the Ethernet protocol.

Technical effects and benefits include a more robust error checking process by utilizing an error checking field that includes end to end error checking. The end to end error checking allows a receiver to use error checking data that was provided by the transmitter and is unchanged as the data is sent via nodes in the network. The unchanged error checking data provides the receiver with an enhanced method of checking the sent data payload and most of the header bits for errors.

As described above, the embodiments of the invention may be embodied in the form of computer-implemented processes and apparatuses for practicing those processes. Embodiments of the invention may also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another.

1. A method for network protocol error correction comprising:
generating a data packet including a cycle redundancy check (CRC) field, an end to end error field that remains unchanged as the data packet is sent over a network, for use in performing error detection in one or more field of the data packet, and a flag field associated with the end to end field to indicate that the end to end error field contains error correction data; and
sending the data packet over a network via an Ethernet protocol.

2. The method of claim 1, wherein the data packet further includes a payload data field and the end to end error field contains CRC data associated with data in the payload data field.

3. The method of claim 1, wherein the data packet further includes a payload data field and the end to end error field contains a checksum associated with data in a payload data field.

4. The method of claim 1, wherein the data packet further includes a payload data field and the end to end error field contains data associated with checking errors in a payload data field.

5. The method of claim 1, wherein the method further comprises receiving a second data packet via an Ethernet protocol.

6. The method of claim 5, wherein the method further comprises determining whether the second data packet includes an end to end error field having end to end error detection data.

7. The method of claim 6, wherein the method further comprises determining whether an error exists in a payload of the second data packet responsive to determining that the second data packet includes an end to end error field having end to end error detection data.

8. A system for transmitting data comprising a transmitter operative to generate a data packet including a cycle redundancy check (CRC) field, an end to end error field that remains unchanged as the data packet is sent over a network, for use in performing error detection in one or more field of the data packet, and a flag field associated with the end to end field to indicate that the end to end error field contains error correction data, and to send the data packet over a network via an Ethernet protocol.

9. The system of claim 8, wherein the data packet further includes a payload data field and the end to end error field contains CRC data associated with data in the payload data field.

10. The system of claim 8, wherein the data packet further includes a payload data field and the end to end error field contains a checksum associate with data in a payload data field.

11. The system of claim 8, wherein the data packet further includes a payload data field and the end to end error field contains data associated with checking errors in a payload data field.

12. The system of claim 8, wherein the system further comprises a receiver operative to receive a second data packet via an Ethernet protocol.

13. The system of claim 8 wherein the receiver is further operative to determine whether the second data packet includes an end to end error field having end to end error detection data.

14. The system of claim 13 wherein the receiver is further operative to determine whether an error exists in a payload of the second data packet responsive to determining that the second data packet includes an end to end error field having end to end error detection data.

15. A computer program product for providing real-time recommendations, the computer program product comprising:
a computer-readable storage medium for storing instructions for executing a real-time recommendation service, the real-time recommendation service comprising a method of:
generating a data packet including a cycle redundancy check (CRC) field, an end to end error field that remains unchanged as the data packet is sent over a network, for use in performing error detection in one or more field of the data packet, and a flag field associated with the end to end field to indicate that the end to end error field contains error correction data; and
sending the data packet over a network via an Ethernet protocol.

16. The computer program product of claim 15, wherein the data packet further includes a payload data field and the end to end error field contains CRC data associated with data in the payload data field.

17. The computer program product of claim 15, wherein the data packet further includes a payload data field and the end to end error field contains a checksum associated with data in a payload data field.

18. The computer program product of claim 15, wherein the real-time recommendation service further comprises the method of:
receiving a second data packet via an Ethernet protocol;
determining whether the second data packet includes an end to end error field having end to end error detection data;
determining whether an error exists in a payload of the second data packet responsive to determining that the second data packet includes an end to end error field having end to end error detection data; and
determining whether an error exists in a payload of the second data packet.
